(19) United States
(12) Patent Application Publication
(10) Pub. No.: US 2016/0344242 A1
(43) Pub. Date: Nov. 24, 2016

(54) VARIABLE MAGNETIC FLUX MOTOR HAVING ROTOR IN WHICH TWO DIFFERENT KINDS OF MAGNETS ARE EMBEDDED

(71) Applicant: NEW MOTECH CO., LTD., Gwangju (KR)

(72) Inventors: Jeong Cheol JANG, Gwangju (KR); Je Hyung SEO, Gwangju (KR); Soo Hyun PARK, Gwangju (KR); Woon Pil JUNG, Suncheon-si (KR); Hugh Jin CHO, Gwangju (KR); Byung Taek KIM, Gunsan-si (KR); Jin Seok JANG, Gimje-si (KR)

(73) Assignee: NEW MOTECH CO., LTD., Gwangju (KR)

(21) Appl. No.: 15/225,827

(22) Filed: Aug. 2, 2016

Related U.S. Application Data
(63) Continuation of application No. 14/387,844, filed on Sep. 25, 2014.

(30) Foreign Application Priority Data
May 2, 2012 (KR) 10-2012-0046057

(51) Int. Cl. H02K 1/02; H02K 1/27

(52) U.S. Cl. CPC H02K 1/02; H02K 1/2773; H02K 1/2786

(57) ABSTRACT

Disclosed is a variable magnetic flux motor having rotor in which two different kinds of magnets are embedded. The variable magnetic flux motor includes: a rotor; a stator located inside of the rotor; and magnets including first magnets and second magnets mounted at outer perimeter of the rotor, four pairs of second magnets being arranged by a right angle based on the rotor, a plurality of unit rotor cores being arranged between each of the four pairs of the second magnets, each of the four pairs of the second magnets is facing each other, wherein an amount of magnetic flux of the second magnets is regulated through a difference in a coercive force generated between the first magnets and the second magnets.

### CROSS REFERENCE TO PRIOR APPLICATIONS

This application is a Continuation of U.S. patent application Ser. No. 14/387,844 filed on Sep. 25, 2014, which is a National Stage Application of PCT International Patent Application No. PCT/KR2013/001373 filed on Feb. 21, 2013, under 35 U.S.C. §371, which claims priority to Korean Patent Application No. 10-2012-0046057 filed on May 2, 2012, which are all hereby incorporated by reference in their entirety.

### BACKGROUND

The present invention relates to a motor. More particularly, the present invention relates to a new structure of a motor, which can be operated at a variable speed by demagnetizing or magnetizing some of magnets applied to a rotor and can obtain high efficiency by concentrating an amount of magnetic flux.

In general, in order to simultaneously obtain a variable speed operation and high efficiency of a motor, various structures and forms of motors have been proposed. Representatively, there are a variable flux memory motor (VFMM) (hereinafter, called “prior art 1”) and a motor disclosed in Japanese Patent Laid-open No. 2009-112454 (hereinafter, called “prior art 2”).

A rotor of the variable flux memory motor according to the prior art 1 is basically similar with a brushless DC electric motor (BLDC motor) of a spoke type. The motor is a motor that permanent magnets are demagnetized from a narrower part thereof due to a difference in thickness of the permanent magnets when a negative d-axis current flows to a d-axis which is a magnetic flux generation axis of a stator. The motor is operated at a variable speed by demagnetizing and magnetizing the permanent magnets based on the above principle.

The motor according to the prior art 2 is basically similar with an outer-rotor type BLDC motor of a salient pole concentrated winding structure. The motor is characterized in that two kinds of magnets with different coercive forces are embedded in a rotor core in such a way as to be arranged in a circumferential direction in turn to thereby form opposite poles. That is, the rotor core has holes for embedding a first magnet and a second magnet therein and protrusions formed on an inner face of the rotor core. Accordingly, the motor according to the prior art 2 has several problems in that the rotor core is complicated in structure and manufacturing costs are increased. Particularly, the first magnet is a neodymium (Nd) magnet, and it is the factor in an increase of manufacturing costs.

In order to solve the above problems of the prior arts, the inventors of the present invention propose a new structure of a motor that includes a rotor of a spoke type and a stator of a salient pole concentrated winding structure to thereby concentrate an amount of magnetic flux, to cause a high performance enhancement, and to reduce manufacturing costs.

Accordingly, the present invention has been made in an effort to solve the above-mentioned problems occurring in the prior arts, and it is an object of the present invention to provide a variable magnetic flux motor of a new structure.

The above and other objects, features and advantages of the present invention will be apparent from the following detailed description of the preferred embodiments of the invention in conjunction with the accompanying drawings.

### SUMMARY

To achieve the above objects, the present invention provides a variable magnetic flux motor, which includes a rotor and a stator located inside the rotor, wherein the rotor comprises a rotor housing, a plurality of unit rotor cores and magnets which are attached to the inner wall face of the rotor housing, and the unit rotor cores and the magnets are arranged in turn, and wherein the stator comprises a stator core base and a plurality of teeth radially formed on the outer peripheral surface of the stator core base at equal intervals, and each of the teeth has ears formed at both sides of an end thereof.

Moreover, the magnets are divided into first magnets and second magnets, and the second magnets are constituted of magnets located at both sides of a pair of opposed unit rotor cores and magnets located at both sides of a pair of unit rotor cores where a connection lines for connecting the two opposed unit rotor cores and a perpendicular line meet each other, and the first magnets are the remaining magnets except the second magnets.

In the present invention, the first magnets are ferrite magnets and the second magnets are alnico magnets.

Furthermore, each of the teeth has a tooth recess inwardly hollowed and formed on the outer peripheral surface of the end portion thereof.

Additionally, each of the ears has an ear recess hollowed inwardly on the outer peripheral surface thereof.

The variable magnetic flux motor according to the present invention is simple in structure, and can reduce manufacturing costs and cause a high performance enhancement because it is favorable to concentration of the amount of magnetic flux.

### DESCRIPTION OF THE DRAWINGS

FIG. 1 is a plan view of a structure of a rotor of a variable magnetic flux motor according to the present invention.

FIG. 2 is a perspective view of a rotor structure of the variable magnetic flux motor according to the present invention.

FIG. 3 is a perspective view of a unit rotor core used in the rotor of the variable magnetic flux motor.

FIG. 4 is a perspective view of a stator of the variable magnetic flux motor.

FIG. 5 is a plan view of the stator of the variable magnetic flux motor.

FIG. 6 is a conceptual view for explaining a change in magnetic flux of the variable magnetic flux motor.

FIG. 7 is a graph showing a counter electromotive force in a magnetized state when the variable magnetic flux motor is in a no-load operation.

FIG. 8 is a graph showing a counter electromotive force in a demagnetized state when the variable magnetic flux motor is in a no-load operation.

FIG. 9 is a graph showing a current characteristic in rated operation when the variable magnetic flux motor is operated at low speed.

FIG. 10 is a graph showing a torque characteristic in rated operation when the variable magnetic flux motor is operated at low speed.

FIG. 11 is a graph showing a current characteristic in the maximum output when the variable magnetic flux motor is operated at low speed.

FIG. 12 is a graph showing a torque characteristic in the maximum output when the variable magnetic flux motor is operated at low speed.

FIG. 13 is a graph showing a current characteristic in rated operation when the variable magnetic flux motor is operated at high speed.

FIG. 14 is a graph showing a torque characteristic in rated operation when the variable magnetic flux motor is operated at high speed.

FIG. 15 is a graph showing a current characteristic in the maximum output when the variable magnetic flux motor is operated at high speed.

FIG. 16 is a graph showing a torque characteristic in the maximum output when the variable magnetic flux motor is operated at high speed.

### DETAILED DESCRIPTION

Hereinafter, reference will be now made in detail to the preferred embodiment of the present invention with reference to the attached drawings.

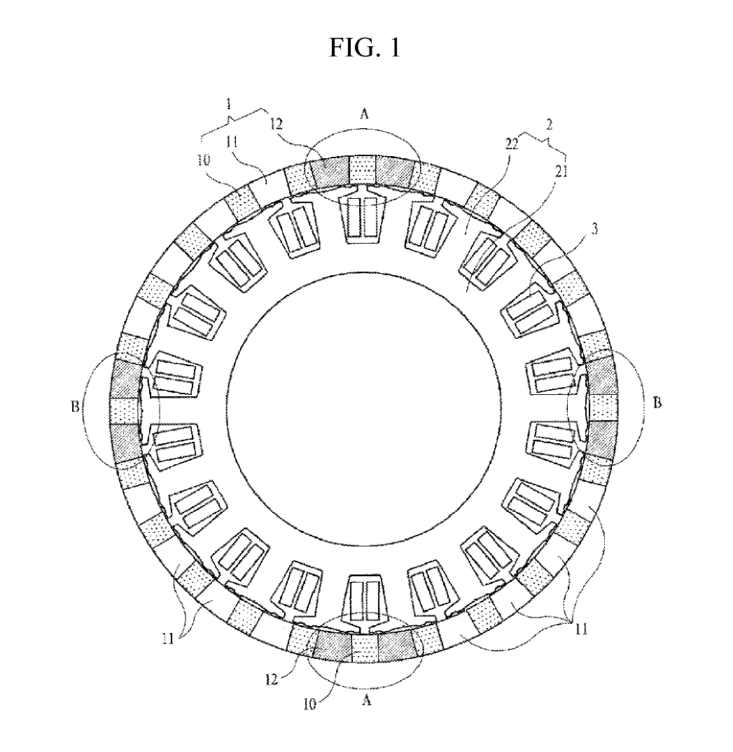

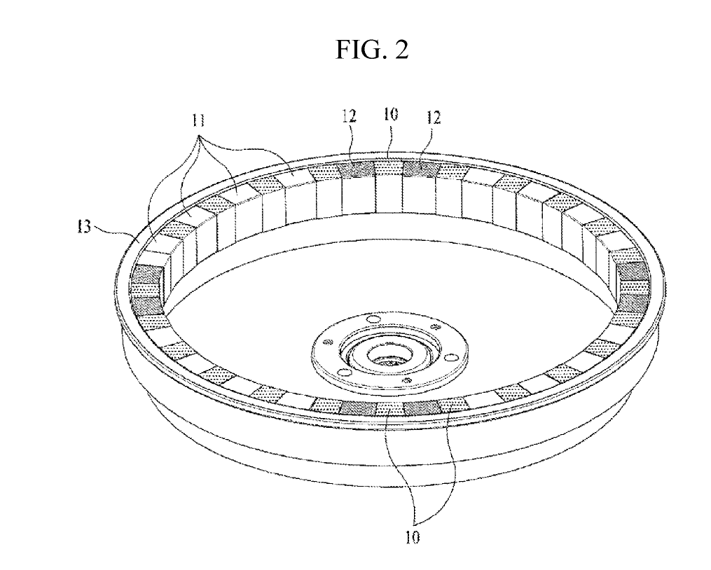

FIG. 1 is a plan view of a structure of a variable magnetic flux motor according to the present invention, and FIG. 2 is a perspective view of a structure of a rotor of a variable magnetic flux motor according to the present invention.

As shown in FIG. 1, the variable magnetic flux motor according to the present invention includes a rotor 1 and a stator 2.

The rotor 1 includes a plurality of unit rotor cores 10, first magnets 11 and second magnets 12, which are located on the outer circumferential surface of the stator 2. As shown in FIG. 2, the unit rotor cores 10, the first magnets 11, and the second magnets 12 are located on the inner side wall surface of a rotor housing 13.

In the present invention, the stator 2 includes a stator core base 21 and a plurality of teeth 22 radially formed on the outer peripheral surface of the stator core base 21.

A coil 3 is wound on the teeth 22 of the stator 2, and occupies some space in a slot formed between two neighboring teeth 22.

As shown in FIGS. 1 and 2, the variable magnetic flux motor according to the present invention adopts a type of 24 poles-18 slots, but the present invention is not limited to the above, and on occasion demands, the number of poles and slots may be varied.

In the case of the motor with 24 poles-18 slots, as shown in FIG. 1, twenty-four unit rotor cores 10 and twenty-four magnets 11 and 12 are located in turn. Out of the twenty-four magnets, sixteen magnets are the first magnets 11 and eight magnets are the second magnets 12. As shown in FIG. 1, the unit rotor core 10 is located between the neighboring magnets, and the second magnets 12 are arranged in the direction of 12 o'clock, 3 o'clock, 6 o'clock, and 9 o'clock by two. In other words, the second magnets are mounted at both sides of the unit rotor core which is opposed to the unit rotor core 10 located between the neighboring second magnets 12 (see the A part of FIG. 1), and the other two second magnets are mounted at both sides of two unit rotor cores where a connection line for connecting the two opposed unit rotor cores and a perpendicular line meet each other (see the B part of FIG. 1). Accordingly, total eight second magnets are applied.

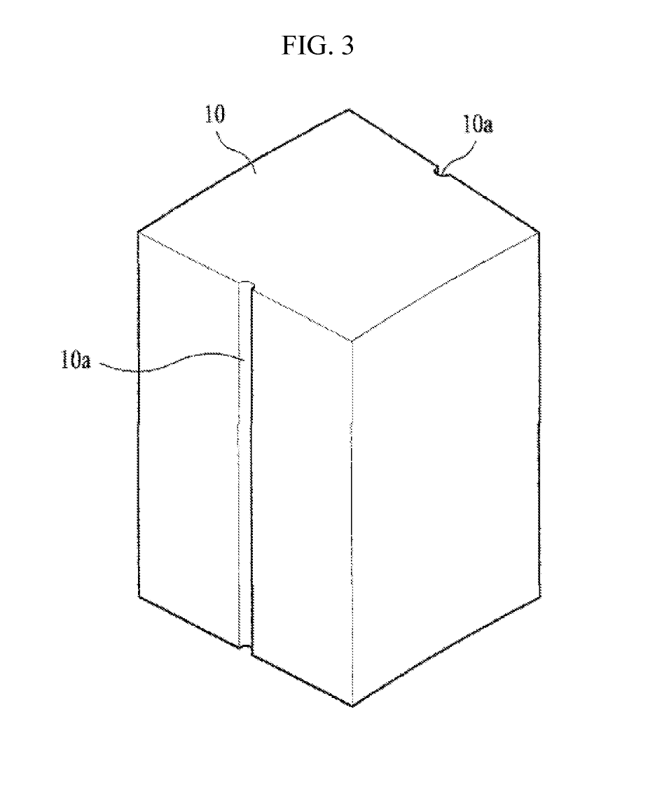

In the present invention, the first magnets 11 are ferrite magnets, and the second magnets 12 are alnico magnets. An amount of magnetic flux of the second magnets 12 can be regulated through a difference in coercive force between the first and second magnets of the two kinds. FIG. 3 is a perspective view of the unit rotor core 10 used in the rotor 1 of the variable magnetic flux motor.

As shown in FIG. 3, the unit rotor core 10 according to the present invention has a structure that the magnets can be attached to both sides thereof, and a plurality of the magnets and a plurality of the unit rotor cores 10 are repeatedly attached so as to generally form a circular shape. In order to be attached to the neighboring magnet, the unit rotor core 10 may have weld lines 10a formed at both sides thereof. The magnet and the unit rotor core can be combined by laser welding along the wed lines 10a. Of course, the attachment method is not limited to the laser welding, and may be adopted from various attachment methods. For instance, caulking or other welding methods may be applied.

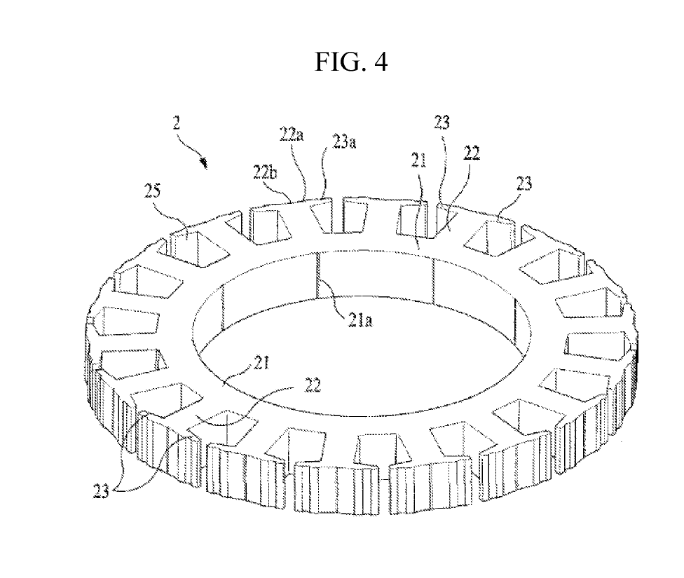

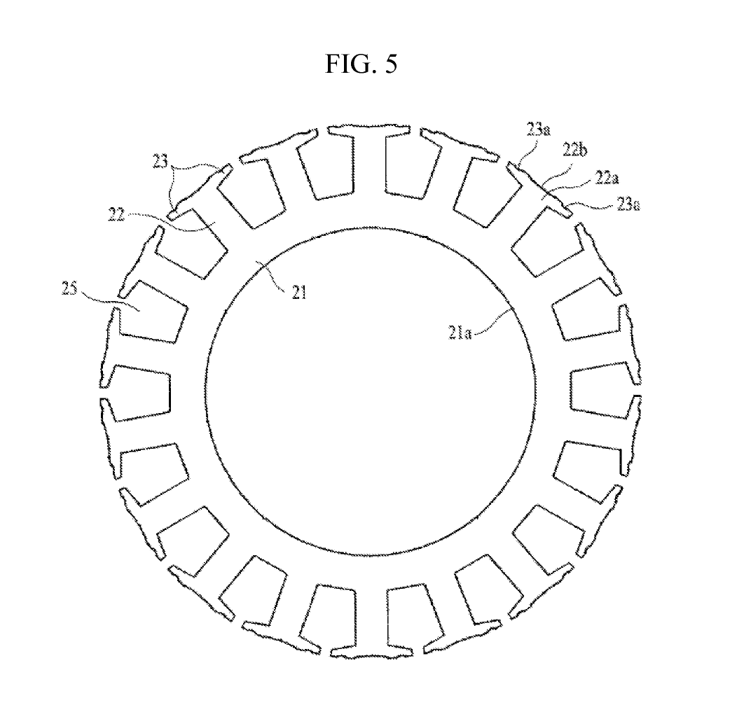

FIG. 4 is a perspective view of the stator 2 of the variable magnetic flux motor, and FIG. 5 is a plan view of the stator 2 of the variable magnetic flux motor.

As shown in FIGS. 4 and 8, the stator 2 according to the present invention includes the circular stator core base 21 and the teeth 22 radially arranged on the outer circumferential surface of the stator core base 21 at equal intervals. Each of the teeth 22 has ears 23 formed at both sides of an end thereof. The stator 2 is formed by core steel sheets laminated repeatedly. The stator core base 21 has a plurality of base welding slots 21a formed on the inner circumferential surface thereof, and laser welding is carried out along the base welding slots 21a so as to firmly fix a plurality of the core steel sheets. Of course, besides the laser welding, caulking or other welding method may be applied.

The space formed between the two neighboring teeth 22 forms a slot 25. The coil is wound on the teeth 22. Each of the teeth 22 has a tooth recess 22a inwardly hollowed a little and formed on the outer peripheral surface of the end portion thereof, and each of the ears 23 formed at both sides of the end of the tooth 22 also has an ear recess 23a inwardly hollowed a little similarly with the tooth recess 22a. The tooth recess 22a and the ear recess 23a serve to reduce a cogging torque which can concentrically generate the amount of magnetic flux.

The tooth recess 22a has a tooth welding slot 22b, and the tooth welding slot 22b serves to combine the stator core sheets together through one of various welding methods like the base welding slots 21a which are described previously.

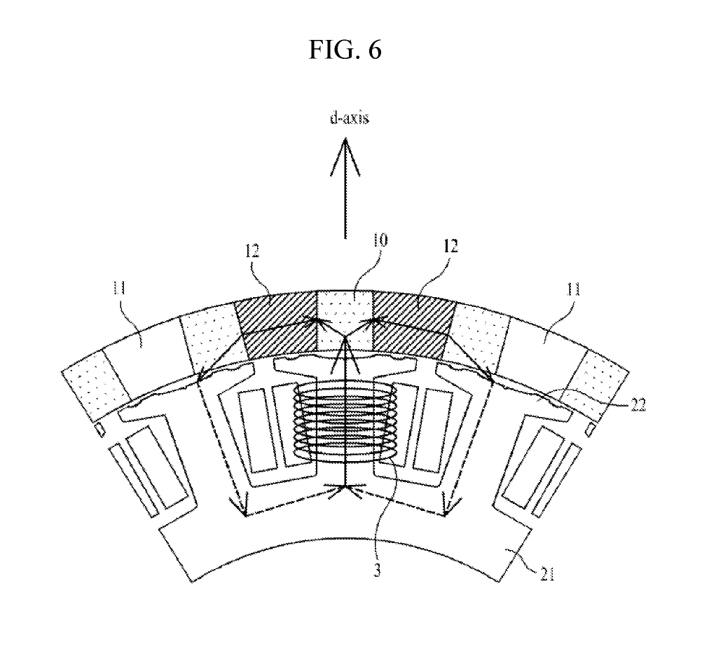

FIG. 6 is a conceptual view for explaining a change in magnetic flux of the variable magnetic flux motor.

Referring to FIG. 6, when the A-phase of the stator is arranged on the unit rotor core 10 between the second magnets 12 which are the alnico magnets, a negative (−) d-axis current flows in the opposite direction to the direction of a magnetomotive force so as to demagnetize the second magnets. Moreover, because it is impossible to simultaneously demagnetize the A part and the B part of FIG. 1, demagnetization may be carried out through the steps of demagnetizing two pairs of the A parts and then demagnetizing two pairs of the B parts.

### EMBODIMENT

In order to analyze demagnetization characteristic of the variable magnetic flux motor according to the present invention, the finite element analysis (FEA) was applied. After the motor with 24 poles-18 slots was manufactured, the FEA was applied under various analyzing conditions. The outer diameter of the rotor of the applied motor was 272 mm, and the stack height of the stator was 25 mm. The diameter of winding was 1.25Φ, and the number of winding was 120 turns. The model name of the ferrite magnets used was pmf-7BE, and the model name of the alnico magnets used was PMC-9B. The magnet was 20 mm long and 16 mm thick. The wire wound resistance was 1.87Ω, d-axis inductance was 38.9 mH, and q-axis inductance was 50.2 mH.

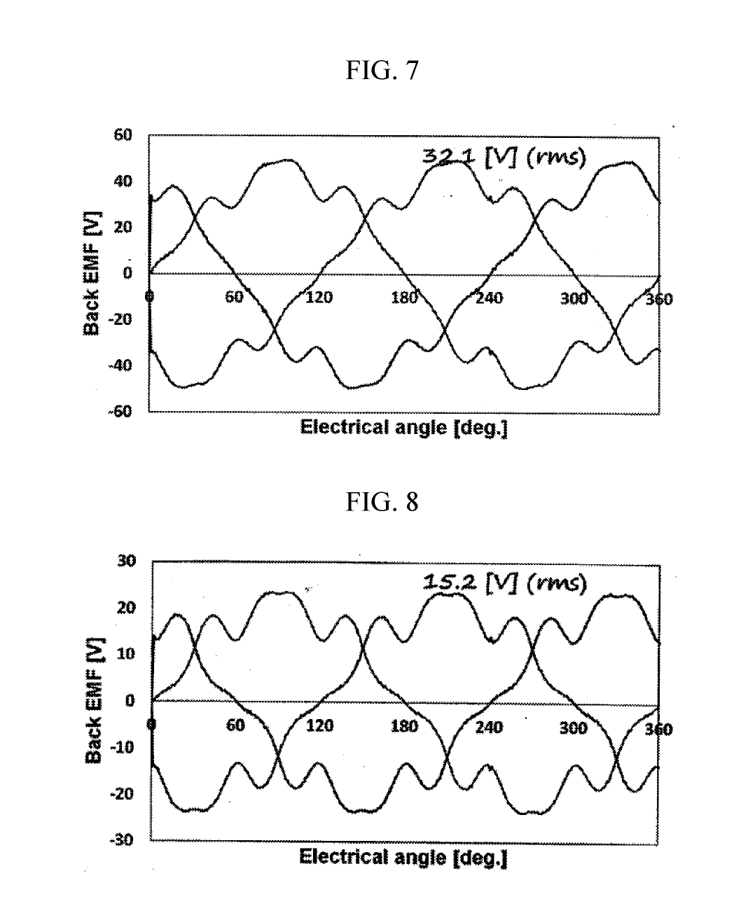

First, under a no-load operation, a counter electromotive force at 150 rpm in full demagnetization was measured. After that, the motor was operated at 150 rpm in a state where the alnico magnets were demagnetized, and then, the counter electromotive force was measure. The measurement results were illustrated in FIGS. 7 and 8. FIG. 7 illustrates the measurement result at the time of full demagnetization and FIG. 8 illustrates the measurement result at the time that the alnico magnets were demagnetized.

As shown in FIGS. 7 and 8, the counter electromotive force at the time of full demagnetization and the counter electromotive force at the time of demagnetization were compared with each other, and then, it was estimated whether or not it was possible to achieve a variable magnetic flux. As a result, variable magnetic flux of about 52.6% was possible.

Next, in order to analyze operation characteristics at low speed, electric current and torque were estimated at 45 rpm under a rated operation state and under the maximum output state. Under the rated operation, a phase voltage peak value was ‘Vph[peak]=43.58[V]’, and under the maximum output operation, a phase voltage peak value was ‘Vph[peak]=46.7[V]’.

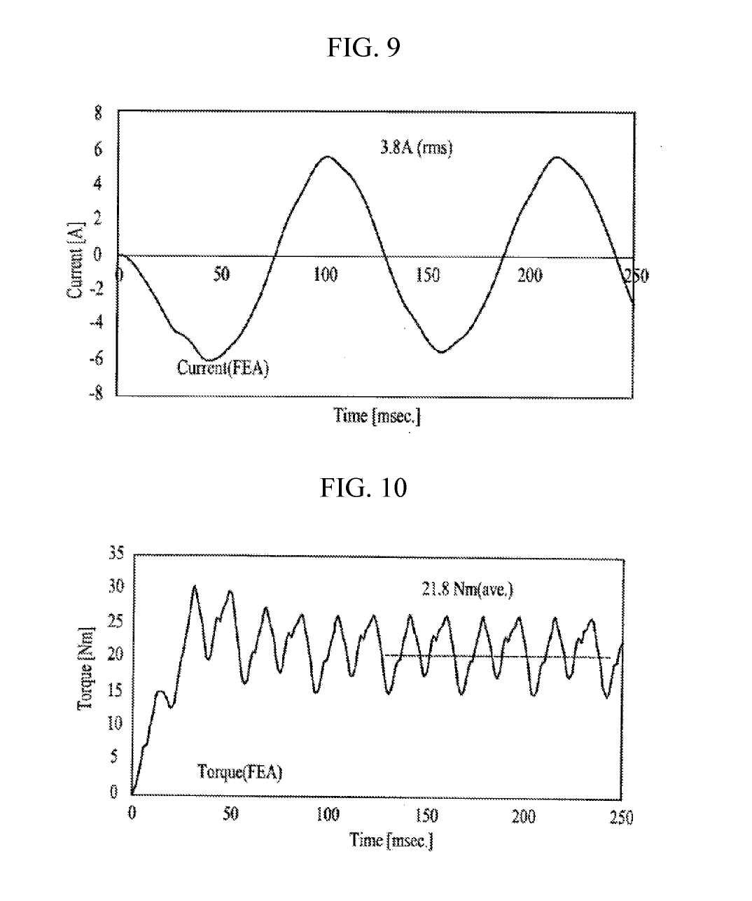

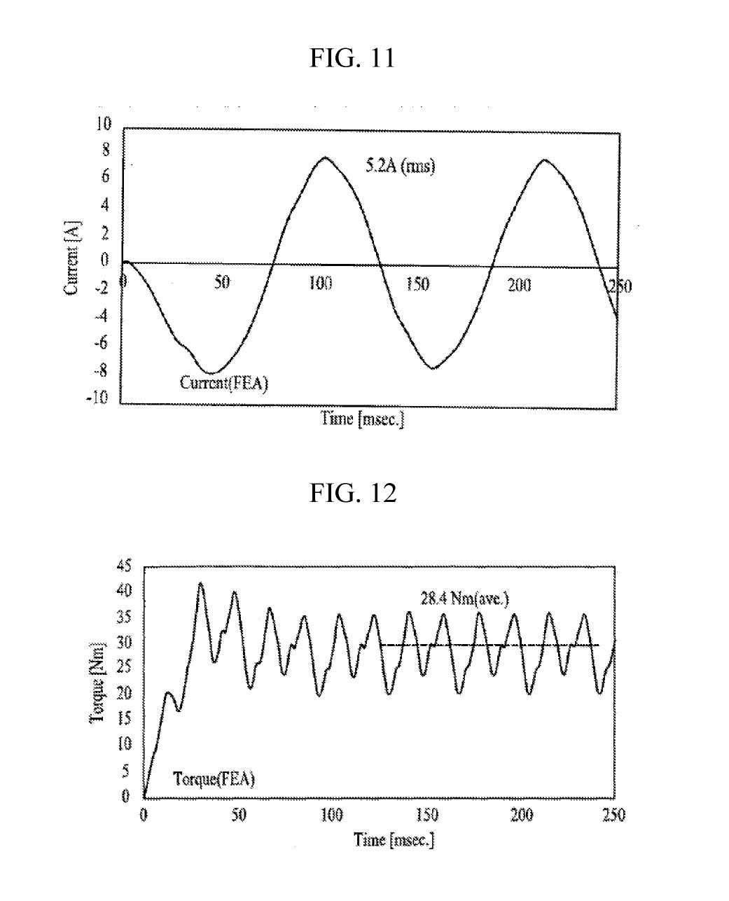

FIGS. 9 and 10 illustrate current characteristics and torque characteristics at low speed under a rated operation state. FIGS. 11 and 12 illustrate current characteristics and torque characteristics under the maximum output operation state.

Next, in order to analyze operation characteristics at high speed, electric currents and torques at 1400 rpm under the rated operation state and under the maximum output operation state were estimated. Under the rated operation, a phase voltage peak value was ‘Vph[peak]=147[V]’, and under the maximum output operation, a phase voltage peak value was ‘Vph[peak]=147[V]’.

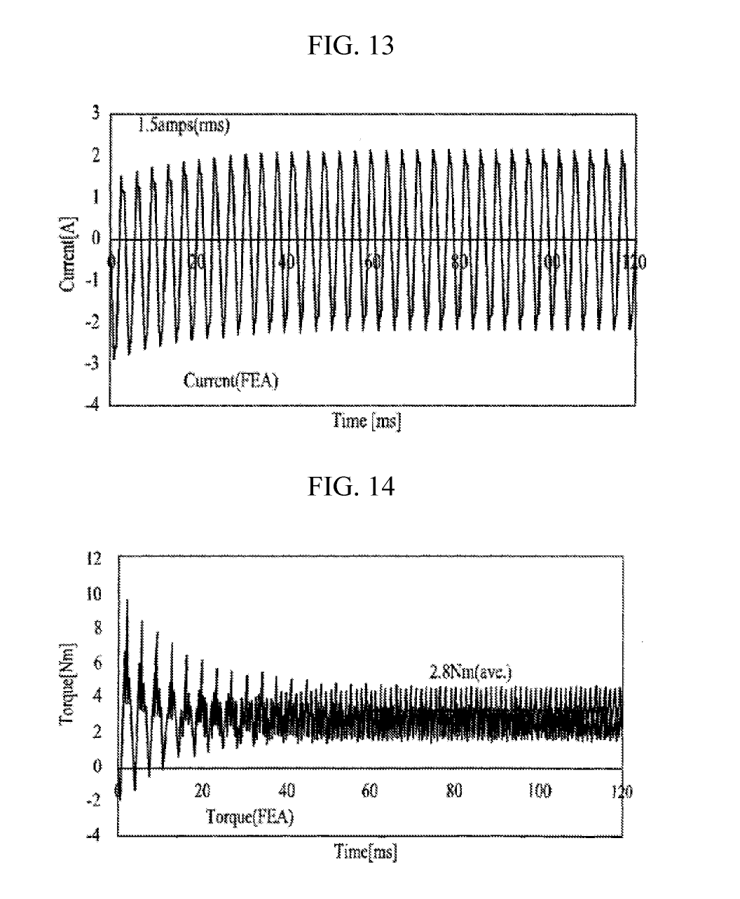

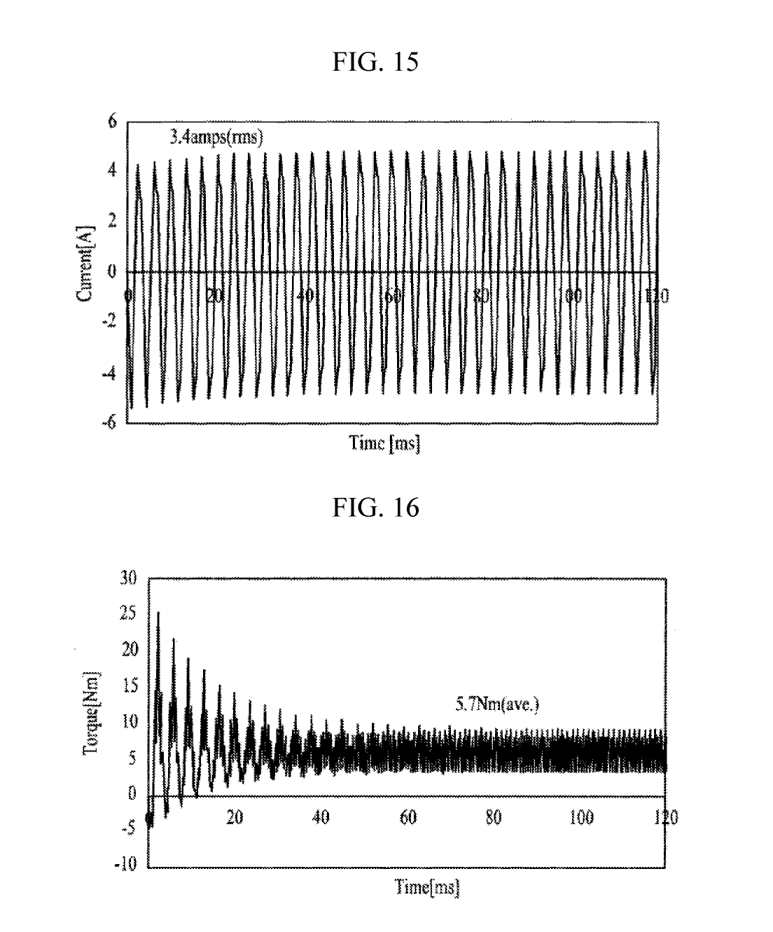

FIGS. 13 and 14 illustrate current characteristics and torque characteristics at high speed under the rated operation state. FIGS. 15 and 16 illustrate current characteristics and torque characteristics under the maximum output operation state.

While the present invention has been particularly shown and described with reference to the preferable embodiment thereof, it will be understood by those of ordinary skill in the art that the present invention is not limited to the above embodiment and various changes or modifications may be made therein without departing from the technical idea of the present invention.

What is claimed is:

1. A variable magnetic flux motor having rotor in which two different kinds of magnets are embedded, the variable magnetic flux motor comprising:
a rotor;
a stator located inside of the rotor; and
magnets including first magnets and second magnets mounted at outer perimeter of the rotor, four pairs of second magnets being arranged by a right angle based on the rotor, a plurality of unit rotor cores being arranged between each of the four pairs of the second magnets, each of the four pairs of the second magnets is facing each other, wherein
an amount of magnetic flux of the second magnets is regulated through a difference in a coercive force generated between the first magnets and the second magnets.

2. The variable magnetic flux motor according to claim 1, wherein the stator includes a stator core base and a plurality of teeth radially formed on the outer peripheral surface of the stator core base at equal intervals.

3. The variable magnetic flux motor according to claim 2, wherein each of the plurality of teeth has a tooth recess inwardly hollowed and formed on the outer peripheral surface of the end portion thereof.

4. The variable magnetic flux motor according to claim 3, wherein tooth recess is configured to reduce a cogging torque which can concentrically generate the amount of magnetic flux.

5. The variable magnetic flux motor according to claim 1, wherein the rotor includes a rotor housing and the plurality of unit rotor cores and magnets being attached to the inner wall face of the rotor housing, the unit rotor cores include weld lines formed at both sides of each of the unit rotor cores.

6. The variable magnetic flux motor according to claim 1, wherein a number of the first magnets are sixteen magnets and a number of the second magnets are eight magnets.

7. The variable magnetic flux motor according to claim 1, wherein the first magnets comprise ferrite magnets and the second magnets comprise alnico magnets, wherein the coercive force of the first magnets is different from a coercive force of the second magnets.
